(19) United States
(12) Patent Application Publication
(10) Pub. No.: US 2012/0166687 A1
(43) Pub. Date: Jun. 28, 2012

(54) Computer Architecture Using Shadow Hardware

(75) Inventor: James G. Baker, El Cajon, CA (US)

(73) Assignee: STMicroelectronics, Inc., Coppell, TX (US)

(21) Appl. No.: 12/976,189

(22) Filed: Dec. 22, 2010

(51) Int. Cl. G06F 3/00; G06F 13/20

(52) U.S. Cl. 710/49; 710/313

(57) ABSTRACT

A shadow hardware system and method is provided. The shadow hardware system provides an interface between an access device and shadowed devices. Shadowed devices are devices that the shadow hardware system provides an interface to the access device although the shadowed device may not actually be present or available to the access device, such as implementing a disk drive as flash memory. The access device, such as a host processor, issues requests to a disk drive and the shadow hardware system converts the requests to requests suitable for the flash memory. A shadow remapper redirects the requests to shadow registers and notifies the shadow controller of the pending request. The shadow controller accesses the shadow registers and modifies the registers (if necessary) before forwarding the registers to the actual hardware devices. Any suitable device may be shadowed.

### TECHNICAL FIELD

The present disclosure relates generally to computer architectures and, more particularly, to a system and method for shadowing peripheral devices of a computer system.

### BACKGROUND

Generally, computer architectures include a host communicatively coupled to peripherals via a system interconnect, such as a bus matrix, wherein the host is a processor or central processing unit that executes user programs. Peripherals include devices such as memory, disk drives, printers, displays, and the like. These peripheral devices are typically connected to the system interconnect via a port or controller interface. For example, in some implementations the system interconnect may have an interface such as a universal serial bus (USB) interface, advanced host controller interface (AHCI), or peripheral component interconnect (PCI) that allows a multitude of different devices to be connected via the bus. For example, it is common to connect cameras, printers, scanners, telephones, etc. to a computer system using a USB connection to the bus.

To access these devices, the host communicates via a set of registers associated with the device controller for the specific device using the system interconnect. As an example, to affect a read of a device such as a disk drive, a host writes configuration registers to the disk drive's device controller, which may, for example, indicate the sector/track where the data is located, the amount of data to be read, and the like. After writing the configuration registers, the host writes a command register to the device controller. Writing the command register to the device controller causes the device to execute the command using the configuration registers.

The device controller interprets the read request and retrieves the requested data from the device. The device controller then returns the requested data to the host interface port to be provided to the host.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a computer architecture utilizing a shadow hardware system in accordance with an embodiment;

FIG. 2 is a flow chart illustrating a process to redirect a request to shadow registers in accordance with an embodiment;

FIG. 3 illustrates a relationship between a shadow target address and shadow cell registers in accordance with an embodiment;

FIG. 4 is a flow chart illustrating a read process of a shadow target address in accordance with an embodiment;

FIG. 5 is a flow chart illustrating a write process of a shadow target address in accordance with an embodiment; and

FIG. 6 is a flow chart illustrating a control process for a host request in accordance with an embodiment.

### DETAILED DESCRIPTION OF ILLUSTRATIVE EMBODIMENTS

The making and using of illustrative embodiments are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

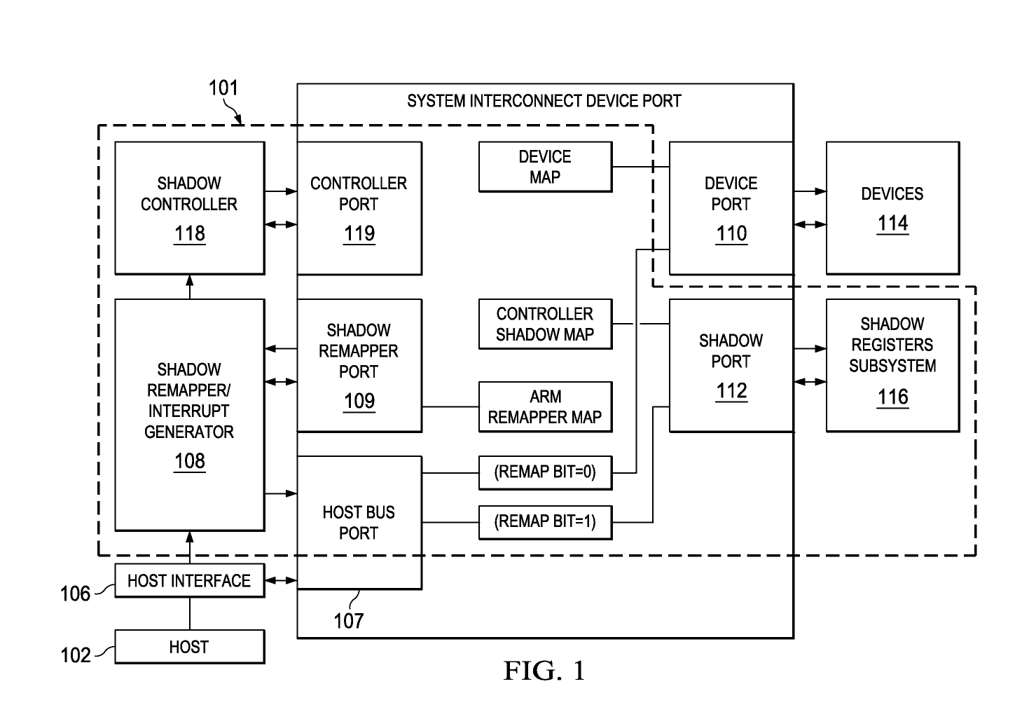

FIG. 1 illustrates a computer architecture 100 incorporating a shadow hardware system 101 in accordance with an embodiment. As will be described in greater detail below, the shadow hardware system 101 interfaces between a host 102 and peripheral devices, indicated in FIG. 1 as devices/device controllers 114. The shadow hardware system 101 allows, among other things, for emulation of a target device by another physical device, such as emulating a disk drive with flash memory, or modifying how a drive operates without substituting it for another type of device. In this example, the host 102 may believe and act as if the host 102 is communicating with a disk drive as the target device, but the shadow hardware system 101 takes the necessary actions to interface with the flash memory, e.g., the physical device.

The target device and the physical device may be the same or different type of device. In the example provided above, the target device, e.g., the disk drive, is a different type of device than the physical device, e.g., the flash memory. In another example, a target device may include two separate disk drives, whereas physically the two separate disk drives are different portions or partitions of a single physical drive.

Referring back to FIG. 1, the host 102 is communicatively coupled to a host interface 106, which acts as a bus interface between the host 102 and a local system interconnect 104, such as a bus matrix, for communication of requests and/or data. The host interface 106 in turn is communicatively coupled to the system interconnect 104 via a host bus port 107. The host interface 106 is further communicatively coupled to a shadow remapper/interrupt generator 108. As will be described in greater detail below, the shadow remapper/interrupt generator 108 is configured to receive or intercept commands issued by the host 102 and to determine how to treat the request, such as either passing the command unmodified to the system interconnect 104 or replacing the address with an address corresponding to the shadow hardware system 101. In an embodiment, the shadow remapper/interrupt generator 108 may determine if the target device of the request is a shadowed hardware device or a non-shadowed hardware device. As such, the shadow remapper/interrupt generator 108 is also communicatively coupled to the system interconnect 104 via the host bus port 107 to redirect requests to a device port 110 (for non-shadowed devices) or a shadow port 112 (for shadowed devices).

Devices and/or device controllers, collectively referred to as devices 114, are communicatively coupled to the system interconnect 104 via the device port 110, and a shadow register subsystem 116 is communicatively coupled to the system interconnect 104 via the shadow port 112. As will be described in greater detail below, the shadow register subsystem 116 provides shadow registers that interface between the host and the shadowed devices. The shadow registers appear to the host 102 as the target device to which the host 102 believes the host 102 is interfacing. In actuality, the host 102 may be interfacing with a different device and/or at a different location. For example, the host 102 may interface with a device that the host 102 believes is a disk drive and communicates with the device as if the device actually is a disk drive. In reality, however, the disk drive may be flash memory. The shadow register subsystem 116 provides registers that to the host 102 appear to be the command/control registers and configuration registers of the disk drive. If the target device is a shadowed device, the shadow remapper/interrupt generator 108 causes the request, or part of the request, issued by the host 102 to be written to the shadow registers of the shadow register subsystem 116 for servicing as explained in greater detail below.

In an embodiment, the devices 114 comprise standard IP blocks purchased from an IP vendor. It will be appreciated that embodiments discussed herein provide a shadow hardware system 101 that, among other things, allow standard IP blocks to be used without modifications to the host 102.

FIG. 1 also illustrates a shadow controller 118 communicatively coupled to the system interconnect 104 and shadow remapper/interrupt generator 108 via a controller port 119. The shadow controller 118 configures the shadow remapper/interrupt generator 108 upon initialization and/or the addition/deletion of hardware devices (shadowed or physical). In an embodiment, the shadow controller 118 responds to interrupts (which may be generated by the shadow remapper/interrupt generator 108), or other indications of host requests, to determine how the shadow hardware system 101 responds to various commands/requests issued by the host 102. If necessary or desired, the shadow controller 118 writes the data placed in the shadow register subsystem 116 (modified or unmodified) to the corresponding device port 110. The shadow controller 118 may also be configured to respond to events initiated by the devices 114. As explained in greater detail below, once the shadow controller 118 is notified of an event from either the host 102 or the devices 114, the shadow controller 118 may be configured to take the desired actions, including absorbing the action/request, allowing the action/request to proceed without modification, allowing the action/request with modification, or the like.

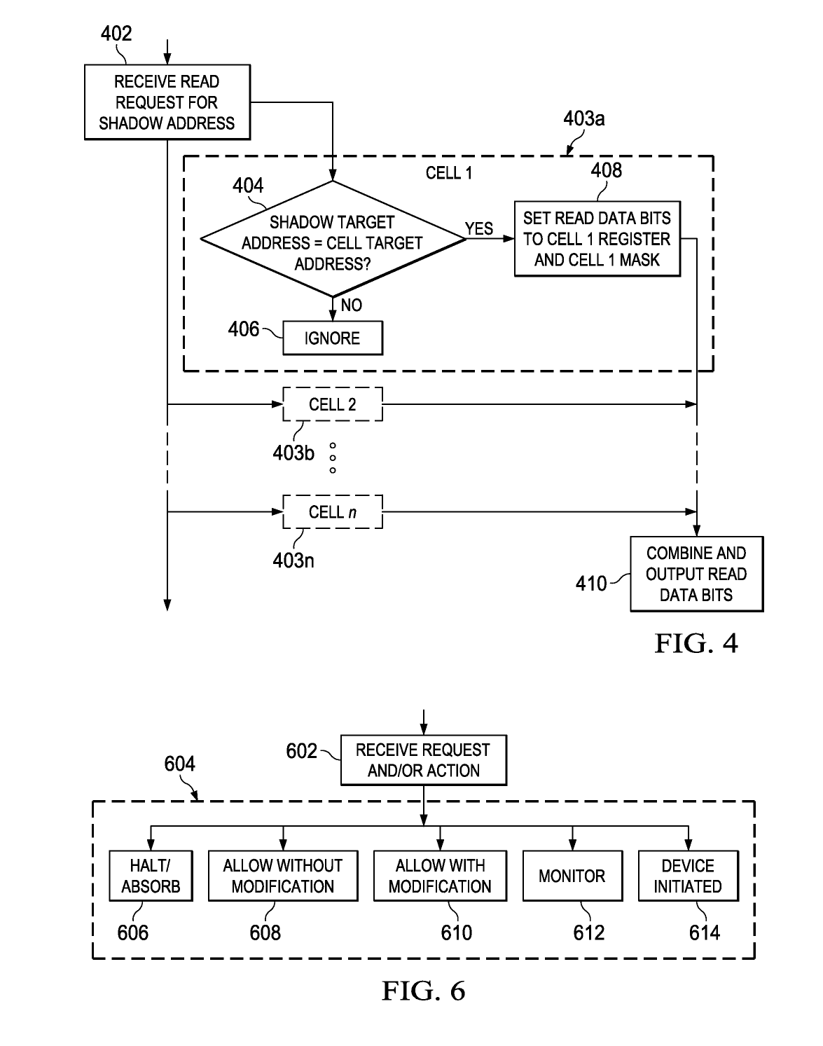

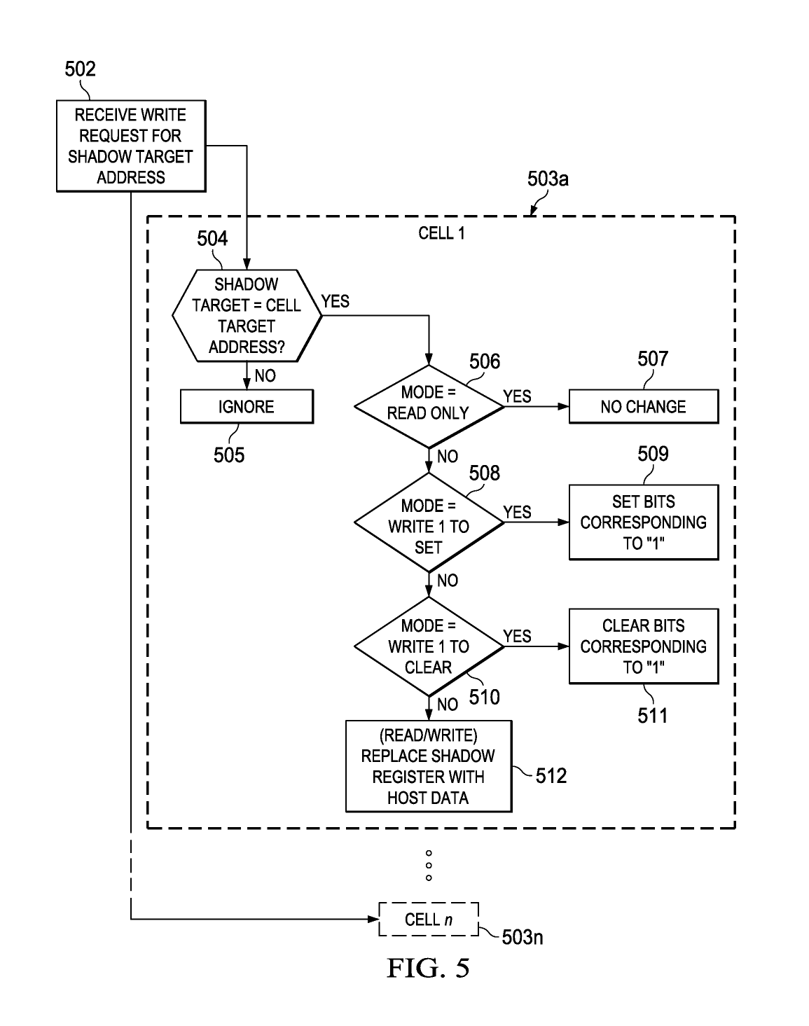

The shadow controller 118 also provides configuration data to the shadow register subsystem 116. As explained below with reference to FIGS. 4 and 5, the target address registers provided by the host 102 may be modified according to mask registers that identify specific bits by the mode (e.g., read only, read/write, etc.). This feature allows different bits to be treated differently as required by the target and actual devices.

Additionally, the shadow remapper/interrupt generator 108 is also communicatively coupled to the system interconnect 104 via the shadow remapper port 109, which provides a communications port by which the shadow controller 118 may initialize and configure the shadow remapper/interrupt generator 108.

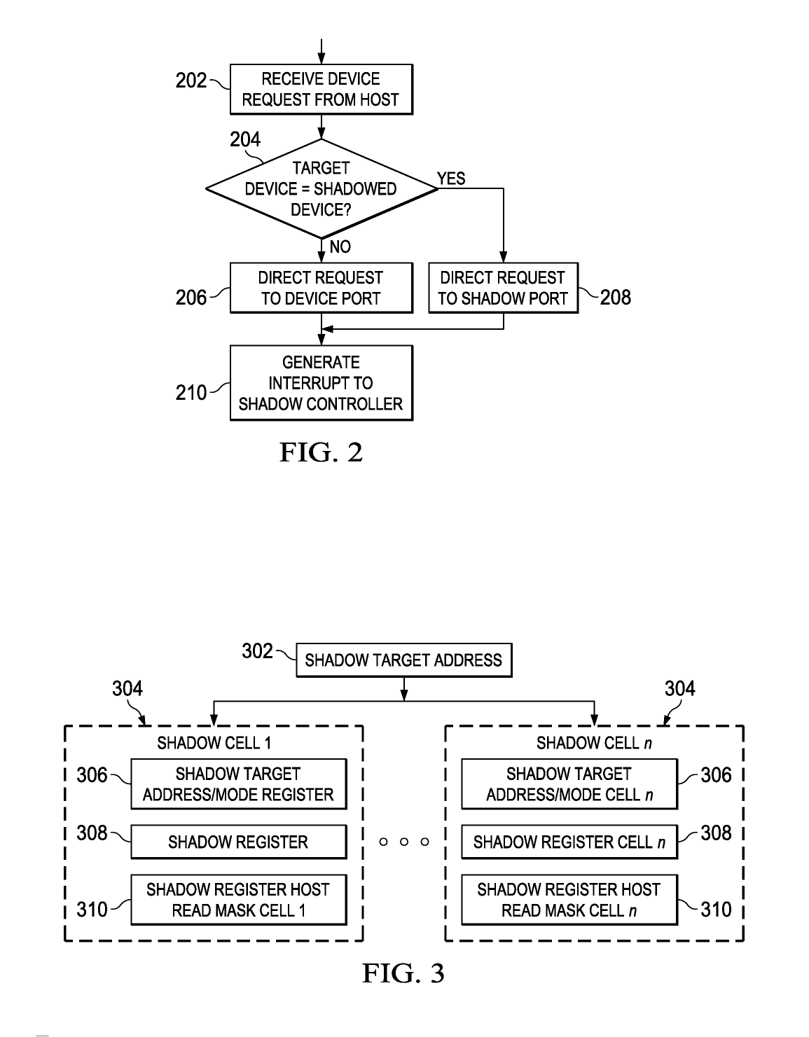

FIG. 2 is a flow diagram illustrating a process that may be performed, for example, by the shadow remapper/interrupt generator 108. The process begins in step 202, wherein the host 102 issues a host request to a target device, such as a data read and/or write request. The shadow remapper/interrupt generator 108 examines the host request issued by the host 102 and determines how and where to issue the host request, such as either passing the command unmodified to the system interconnect 104 or replacing the address with an address corresponding to the shadow hardware system 101. In step 204, a determination is made whether or not the target device that the host 102 is attempting to access is a shadowed device. In an embodiment, the shadow remapper/interrupt generator 108 maintains a list of device addresses that has been configured to be shadowed. The list of device addresses may be provided to the shadow remapper/interrupt generator 108 by, for example, the shadow controller 118 upon initialization. Accordingly, in an embodiment, step 204 indicates the process of the shadow remapper/interrupt generator 108 determining whether or not the target device is a shadowed device.

If a determination is made that the target device is not a shadowed device, then the shadow remapper/interrupt generator 108 directs the host request to the device port 110 as indicated in step 206. Otherwise, the shadow remapper/interrupt generator 108 directs the host request to the shadow port 112, as indicated in step 208. In an embodiment, the device port 110 or the shadow port 112 is selected by the shadow remapper/interrupt generator 108 by clearing or setting, respectively, a remap bit as indicated in FIG. 1. In this embodiment, clearing the remap bit causes the host target address to be presented on the system interconnect 104, and setting the remap bit causes the remapped address (corresponding to the shadow port 112) to be presented on the system interconnect 104.

Thereafter, the shadow remapper/interrupt generator 108 may optionally generate an interrupt to signal to the shadow controller 118 that an access to an actual device or a shadowed device has been requested. It should be noted that in some embodiments, an interrupt may be made for only one of an access to the device port 110 and an access to the shadow port 112, or made for an access to either of the device port 110 and the shadow port 112. For example, in some embodiments, it may be desirable to interrupt the shadow controller 118 only on accesses to the shadow port 112, and allowing accesses to the device port to continue without interrupting the shadow controller 118. This embodiment may be desirable in situations in which the shadow controller 118 has no need to know of accesses to the target device. In other embodiments, however, it may be desirable to interrupt the shadow controller 118 on accesses to non-shadowed devices such that the shadow controller 118 may oversee or control the accesses to the target devices.

It should be noted that interrupts are used for illustrative purposes only and that other embodiments may utilize other mechanisms. As explained in greater detail below, once the host request is written to the shadow register subsystem 116, an embodiment utilizes the shadow controller 118 to modify (if necessary) the request and to direct the request to the actual device on the device port 110. In this embodiment, the shadow controller 118 is notified of the request pending in the shadow register subsystem 116. Interrupts are one example of a mechanism that may be used to notify the shadow controller 118 of the pending request. Other embodiments may utilize other mechanisms, such as polling the shadow registers, polling some other memory location, (non-interrupt) messaging, and/or the like.

FIG. 3 illustrates a plurality of shadow cells associated with a shadow target address in accordance with an embodiment. Each shadow target address 302, provided to the shadow registers subsystem 116 by the shadow remapper/interrupt generator 108, has one or more shadow cells 304. Each shadow cell 304 comprises a shadow target address/mode register 306, a shadow register 308, and a shadow register host read mask 310. The shadow target address/mode register 306 represents the shadow target address 302 for which that particular shadow cell 304 is associated. In an embodiment, the shadow target address/mode register 306 includes a shadow enable bit and a mode indication comprising one or more bits that indicate the write mode associated with the bits defined in the shadow cell 304. The shadow enable bit enables the corresponding shadow cell and allows the shadow target address matching logic, explained below, to be performed. The mode indication may indicate that all bits in the associated shadow register 308 are, for example, read only, write “1” to set, write “1” to clear, and read/write. Other embodiments may use other modes.

The shadow register host read mask 310 indicates which bits of the shadow register 308 in each respective shadow cell 304 will be provided in response to a read request. The shadow register 308 is the current value of the device register of the particular shadow cell 304. As illustrated in FIG. 3, however, one specific shadow target address 302 may have multiple shadow cells 304. As explained in greater detail below, the value read from a single shadow target address 302 comprises the union of each shadow register 308 associated with the shadow target address 302. In this manner, complex registers having bits with differing characteristics (e.g., some read only bits, some reserved bits, etc.) may be accurately shadowed.

FIG. 4 illustrates a read process that may be performed by, for example, the shadow registers subsystem 116 using the shadow target address 302 relationships illustrated in FIG. 3 in accordance with an embodiment. The process illustrated in FIG. 4 may be triggered by the receipt of a host read request of a shadow target address 302. As noted above, the shadow remapper/interrupt generator 108 receives the host read request and a target address from the host 102. The shadow remapper/interrupt generator 108 determines that the target address of the host read request is a shadowed device and translates the target address to a corresponding shadow target address 302, which is then provided to the shadow registers subsystem 116 as indicated at step 402.

Upon receipt of the host read request and the shadow target address 302, the shadow target address 302 is provided to shadow processing cells 1-n. The shadow registers subsystem 116 may be configured to have multiple shadow processing cells, where each shadow processing cell may be configured to respond to a specific shadow target address 302 as defined by the shadow target address/mode register 306, the shadow register 308, and the shadow register host read mask 310 discussed above with reference to FIG. 3. Multiple shadow cells 304, however, may respond to a single shadow target address 302, as will be explained in greater detail below. The configuration and/or initialization of the shadow cells 304 may be performed, for example, by the shadow controller 118 during power-up initialization or during runtime.

The shadow target address 302 received from the shadow remapper/interrupt generator 108 is provided to the shadow processing cells, illustrated by the dotted boxes 403a-403n, collectively referred to as shadow processing cells 403. Additional details of the shadow cells 403 are provided for shadow cell 403a. Shadow cells 403b-403n may perform similar processes.

At step 404, a determination is made whether or not the shadow target address 302 provided by the shadow remapper/interrupt generator 108 matches the address included in the shadow target address/mode register 306 associated with that particular shadow cell 304. If the shadow target address 302 does not match the address included in the shadow target address/mode register 306 of the particular shadow processing cell 403, then no processing is performed as indicated at step 406. Otherwise, at step 408, when the shadow target address 302 provided by the shadow remapper/interrupt generator 108 matches the address included in the shadow target address/mode register 306, the bits of the shadow register 308 corresponding to the bits set in the associated shadow register host read mask 310 are selected. In step 410, the selected bits from the shadow processing cells 403 responsive to the shadow target address 302 provided by the shadow remapper/interrupt generator 108 are combined and provided as the resulting read data. As explained above, each of the shadow registers 308 comprise all bits of the register, such as all 32 bits. When multiple shadow cells, say 4, are used to represent a single shadow register, then the total number of bits exceed the size of the registers, 128 in this example. The shadow register host read mask 310 operates to reduce the total number of bits back down to the size of the register 32 by only selecting the relevant bits from each shadow register.

FIG. 5 illustrates a write process to a shadow register in accordance with an embodiment. Before proceeding, it should be noted that the write process described below uses a shadow target address 302 having four shadow cells 304: one for read-only bits, one for write “1” to set bits, one for write “1” to clear bits, and one for read/write bits. Other modes, fewer or more, may be used in other embodiments.

Similar to the read shadow register process illustrated in FIG. 4, the write shadow register may be triggered by the receipt of a host write request of a shadow target address 302. The shadow remapper/interrupt generator 108 receives the host write request for a target address and the data to be written from the host 102. The shadow remapper/interrupt generator 108 determines that the target address of the host read request is a shadowed device and translates the target address to a corresponding shadow target address 302, which is then provided to the shadow registers subsystem 116 as indicated at step 502.

Upon receipt of the host write request and the shadow target address 302 as indicated by step 502, the shadow target address 302 is provided to shadow processing cells 1-n, each shadow processing cell configured to respond to a specific shadow target address 302 as defined by the shadow target address/mode register 306. The shadow target address 302 received from the shadow remapper/interrupt generator 108 is provided to the shadow processing cells, illustrated by the dotted boxes 503a-503n, collectively referred to as shadow processing cells 503. Additional details of the shadow processing cells 503 are provided for shadow processing cell 503a. Shadow processing cells 503b-503n may perform similar processes.

At step 504, a determination is made whether or not the shadow enable bit is set and whether or not the shadow target address 302 provided by the shadow remapper/interrupt generator 108 matches the target address within the shadow target address/mode register 306 associated with that particular shadow cell. If the shadow target address 302 does not match the target address in the shadow target address/mode register 306 of the particular shadow cell 304, then no processing is performed as indicated at step 505.

Otherwise, the mode bits of the corresponding shadow target address/mode register 306 are evaluated to determine how the respective shadow register is to be written, if at all. For example, in step 506, the corresponding mode bits within the shadow target address/mode register 306 indicate that the shadow register 308 of that particular shadow cell 304 is read only, in which case no change is made to the shadow register 308 as indicated at step 507. If the mode bits indicate that the mode is write “1” to set as indicated in step 508, then in step 509 the bits corresponding to “1” in the data provided by the host 102 is set to a “1” in the shadow register.

Steps 510 and 511 indicate a mode of write “1” to clear, where the bits corresponding to a “1” in the data provided by the host 102 are cleared in the shadow register 308 and bits corresponding to a “0” in the data from the host 102 are left unchanged. Step 512 indicates a mode of read/write in which the host 102 has full read/write access to the target address registers. In this read/write mode, the shadow register is replaced with the data provided by the host.

Referring now to FIG. 6, a process that may be used by the shadow controller 118 is illustrated. It should be noted that the process illustrated in FIG. 6 is but one example. It should be appreciated that the shadow controller 118 provides customization of the transactions between the host 102 and the devices 114. As such, the shadow controller 118 provides a mechanism by which the shadow hardware system 101 may be customized to react to the various requests and events within the system, whether generated from the host 102 or the devices 114, with little or no changes to the host software or firmware. As such, the shadow controller 118 may be configured to provide special capabilities and/or functionality to specific commands. As an example, some of those capabilities are illustrated in FIG. 6, but other embodiments may utilize different capabilities.

The process begins in step 602, wherein the shadow controller 118 receives an indication that the host 102 and/or the devices 114 has issued a request or performed some action. As indicated above, the shadow controller 118 may be notified of the pending request in any suitable manner, including interrupts, polling, messaging, or the like. Once notified of the pending request or action that may require processing, the process proceeds to step 604, wherein the appropriate action is taken. Within step 604, there are listed five examples of types of processing that may be performed by the shadow controller 118 for illustrative purposes only. The shadow controller 118 may perform less, more, and/or different actions as desired for a particular application or device.

Referring first to action 606, in some instances, such as power-up or initialization modes, it may be desirable to halt the request. In another example, the host 102 may issue a request for a target device that is inapplicable to the actual device, such as may be the case if the host 102 issues a seek command for a disk drive when the disk drive is shadowed as flash memory. In this case, the seek command is inapplicable to the flash memory.

In these situations, the processing may proceed to step 606, wherein the request is halted or absorbed. If the request was issued to the shadow registers subsystem 116, the request may be halted by taking no further action. As part of the process of halting the command, the shadow controller 118 may need to issue a response, such as an acknowledgement, to the host 102. Generally, if the device being shadowed would have issued a response to the host, such as indicating completion of the task, then it may be desirable for the shadow controller 118 to issue a response as if the target device were actually communicating with the host 102.

Action 608 allows the shadow controller 118 to allow the action without modification. If the shadow registers are in the correct format, then the shadow controller 118 may pass the shadow registers to the devices 114 without any further modification.

On the other hand, action 610 is desirable when additional processing is necessary or desired before passing the request or action to the target device, e.g., the devices 114, the host 102, or the like. In this example, the shadow controller 118 retrieves the corresponding shadow registers corresponding to the request from the shadow register subsystem 116. Because the target device being accessed by the host 102 may not necessarily correspond to the actual device, such as the host accessing a disk drive as the target device that is implemented as flash memory as an actual device, the request may require modification to reflect the access requirements of the actual device. As another example, if the host 102 attempts to write to a complex register that includes read-only bits, the shadow controller 118 may read the actual device to obtain the values of the read-only bits before processing the write command. Yet another example is that the shadow controller 118 may enable command queuing for a disk drive coupled to device port 114, even thought the host 102 chose not to enable command queuing. Thus, if modification is necessary, the shadow controller 118 modifies the request. Thereafter, the shadow controller 118 issues the request (modified as necessary) to the respective device port 110 and devices 114.

Action 612 allows a monitoring function to be implemented by the shadow controller. As discussed above, the shadow remapper/interrupt generator 108 may be configured to generate an interrupt to or otherwise notify the shadow controller 118 of any request issued by the host 102, even if the target device is not a shadowed device. This allows the shadow controller 118 to monitor the activity between the host 102 and the devices 114.

Action 614 provides the ability for the shadow controller 118 to respond to the communications originating from the devices 114. In one example, a device may generate an interrupt when the device changes a status register used by the host 102. In these cases, it may be desirable for the shadow controller 118 to intercept the interrupt (or other messaging) from the device. In response, the shadow controller 118 may decide if the device is a shadowed device, and if it is not a shadowed device, allow the interrupt to proceed to the host 102. If the device is a shadowed device, however, the shadow controller 118 may read the device status register of the device and update the corresponding shadow registers in the shadow register subsystem 116. After updating the shadow registers, the shadow controller 118 may cause an interrupt to the host 102, which then may issue a read request of the shadow registers.

It should be appreciated from the above description that in an embodiment the shadow controller 118 has full read/write access to the registers of the shadow register subsystem 116. This allows the shadow controller 118 not only to provide initialization and configuration of the registers, but also to place current data in the shadow registers for actions such as host reads.

While this detailed description has set forth some embodiment of the present invention, the appended claims cover other embodiments of the present invention which differ from the described embodiments according to various modifications and improvements. For example, the state information may include more or less data, the application computing elements themselves may be a virtual computing environment, and/or the like.

Within the appended claims, unless the specific term “means for” or “step for” is used within a given claim, it is not intended that the claim be interpreted under 35 U.S.C. 112, paragraph 6.

What is claimed is:

1. A computer architecture comprising:
a system interconnect;
one or more device ports on the system interconnect;
one or more shadow registers communicatively coupled to the system interconnect to receive requests directed to a first device; and
a shadow controller communicatively coupled to the system interconnect, the shadow controller causing communications from one of the first device and a second device to be written to the shadow registers, the shadow controller modifying at least one of the communications prior to providing the communications to the other of the first device and the second device.

2. The computer architecture of claim 1, wherein the system interconnect is a bus.

3. The computer architecture of claim 1, further comprising one or more shadow register host read masks, each of the shadow register host read masks indicating a property of specific bits of the respective shadow register.

4. The computer architecture of claim 3, wherein a plurality of shadow registers define a single target address.

5. The computer architecture of claim 1, further comprising a shadow remapper, the shadow remapper directing a request to either a first shadow register or a device.

6. The computer architecture of claim 1, further comprising an interrupt generator, the interrupt generator being communicatively coupled to the shadow controller, the interrupt generator providing an indication that a request was written to the one or more shadow registers.

7. The computer architecture of claim 6, wherein the indication comprises an interrupt.

8. A shadow hardware system comprising:
a shadow remapper to receive requests for a target device;
one or more shadow registers, the shadow remapper redirecting requests for the target device to the shadow registers; and
a shadow controller communicatively coupled to the shadow registers, the shadow controller directing the requests for the target device to a first device.

9. The shadow hardware system of claim 8, wherein the first device and the target device are the same device.

10. The shadow hardware system of claim 8, wherein the shadow remapper directs requests for a second device to the second device when the second device is not shadowed.

11. The shadow hardware system of claim 8, wherein the shadow controller is communicatively coupled to the shadow remapper, the shadow remapper providing an interrupt to the shadow controller upon a write to the shadow registers.

12. The shadow hardware system of claim 11, wherein the shadow controller provides an interrupt to the shadow controller when the request is not directed to the shadow registers.

13. The shadow hardware system of claim 8, further comprising one or more mask registers for each respective shadow registers, each of the one or more mask registers indicating a behavior for one or more bits of the respective shadow registers.

14. The shadow hardware system of claim 8, wherein the shadow controller modifies the requests prior to providing the requests to the first device.

15. A method comprising:
receiving a target register from a host, the target register being directed to a target device;
determining whether or not to redirect the target register is a shadowed register;
redirecting, when the target register is a shadowed register, the target register to one or more shadow registers;
combining the one or more shadow registers to form one or more device registers, the one or more shadow registers being different than the one or more device registers; and
providing the one or more device registers to a device port.

16. The method of claim 15, wherein each of the one or more shadow registers has a corresponding mask register, and further comprising selecting bits from the one or more shadow registers as indicated by the corresponding mask register.

17. The method of claim 15, wherein the combining is performed at least in part by checking a mode associated with a shadow target address of each of the shadow registers, the mode indicating a type of bits in each of the shadow registers.

18. The method of claim 15, further comprising receiving a communication from a device coupled to the device port, and redirecting the communication from the device to the shadow registers.

19. The method of claim 15, further comprising providing an interrupt to signal that the target register has been redirected to the one or more shadow registers.

20. The method of claim 15, further comprising providing an interrupt to signal that a target register is being accessed when the target register is not a shadowed register.
